(19) United States
(12) Patent Application Publication
(10) Pub. No.: US 2006/0136339 A1
(43) Pub. Date: Jun. 22, 2006

(54) System and method for protecting unprotected digital contents

(75) Inventors: Jae-Un Kim, Seoul (KR); Kiran Kumar Keshavamurthy, Bangalore (IN)

Correspondence Address: LEE, HONG, DEGERMAN, KANG & SCHMADEKA, 14th Floor, 801 S. Figueroa Street, Los Angeles,, CA, 90017, US

(73) Assignee: LG Electronics Inc.

(21) Appl. No.: 11/272,114

(22) Filed: Nov. 9, 2005

Related U.S. Application Data
(60) Provisional application No. 60/626,807, filed on Nov. 9, 2004.

(30) Foreign Application Priority Data
Jun. 11, 2005 (KR) 10-2005-50129

(51) Int. Cl. G06Q 99/00

(52) U.S. Cl. 705/51

(57) ABSTRACT

A system for protecting contents comprises a first device for storing and reproducing contents purchased by a user; a server for issuing usage rights of contents; and a second device for reproducing contents protection mechanism-applied contents, and if contents to be copied from the first device are not protected by the protection mechanism, obtaining the usage rights from the server and converting the unprotected contents into contents under protection of the protection mechanism. When contents purchased by the user is not protected by the DRM, the DRM-employed reproducing device can obtain usage rights with respect to the corresponding contents from the rights issuer. And then, the purchased contents are converted into the contents that can be protected by the DRM. Accordingly, in the present invention, the contents that is not protected by the DRM can be enjoyed through the DRM-employed reproducing device without causing a problem legally, and thus, user inconvenience of separately and additionally purchasing contents protected by the DRM and a corresponding financial loss can be reduced.

### CROSS REFERENCE TO RELATED APPLICATIONS

This application claims the benefit of U.S. Provisional Application No. 60/626,807 filed on Nov. 9, 2004 and Korean Application No. 50129/2005, filed on Jun. 11, 2005, which are hereby incorporated by reference in their entirety.

### BACKGROUND OF THE INVENTION

1. Field of the Invention

The present invention relates to an open mobile alliance (OMA) and, more particularly, to a system and method for protecting OMA-based contents.

2. Description of the Related Art

Development of mobile communications has made communication markets grow rapidly, and in line with this, demands for the wireless Internet are gradually increasing. Standardization groups are changing their focus from the network standards regarding a fixed line to utilization of the wireless Internet.

Of them, the OMA established in June 2002 is anticipated to help activate the latent wireless Internet markets. In spite of some controversial backgrounds regarding generation of the OMA, potential power of the OMA cannot be overlooked in the current situation.

The OMA has a close relationship with other various standard organizations related to the mobile industry in order to obtain interoperability.

Through a merge and cooperative relation with the standard organizations, the OMA receives standards developed by an external organization or collects its requirements. In case of an MMS (Multimedia Messaging Service), the most conspicuous example in the messaging field, it collects requirements of a GSMA and CDG and develops standards for the 3GPP and 3GPP2 network layer. In case of a DRM (Digital Rights Management), it received a DRM specification of the 3GPP June 2002 and has revealed OMA DRM v1.0 of a candidate stage.

The DRM, a technique for protecting contents against illegal circulation and distribution, has been developed to guarantee a stable distribution of paid contents (contents to be used upon payment) through a Web and prevent the illegal distribution. The DRM protects the rights and benefits of contents providers, prevents illegal copying of contents, and comprehensively supports generation, circulation and management of contents such as charging of a usage fee and acting for payment (e.g. service fee charging and a third party payment).

The DRM includes a digital copyright management technique allowing only an authorized user to use contents and pay an appropriate fee, a software and security technique for authenticating and executing copyrights, and a payment and settlement technique.

Although online contents are protected by a copyright law, it is virtually difficult to prevent illegal copying or indiscriminate distribution of paid contents. Compared with a random strategy that a concerned party is arrested after illegal copying or distribution of paid contents occurs, the DRM technique is rather a basic problem solution approach focusing on not allowing stealing of Web contents at an initial stage. Manufacturers have presented various DRM products based on various approaches and techniques. In general, DRM products have a collective package form including everything required for operations such as server software and a plug-in for users.

The DRM technique was initially adopted by Napster, which is widely known for providing a music-sharing service, for protecting MP3 copyrights in the year of 2001, and as online contents are turned for being payment-based, the DRM technique has emerged as an important technique and selected as the future core information technique by research institutions of many countries.

However, the related art digital contents protection system such as the DRM has the following problems.

That is, in order for a user to enjoy contents by using the DRM-applied device, the user must buy contents protected by the DRM. Namely, in the related art DRM technique, although the user owns contents purchased from offline (or online), he/she cannot enjoy the corresponding contents with the DRM-applied device. In order to enjoy the contents with the DRM-applied device without causing a problem in a legal aspect, the user have no choice but buy contents protected by the DRM.

### BRIEF DESCRIPTION OF THE INVENTION

Therefore, an object of the present invention is to provide a system and method for protecting unprotected digital contents capable of allowing a user to enjoy purchased unprotected contents with a contents protection technique-employed media reproducing device without causing a legal problem.

To achieve at least the above objects in whole or in parts, there is provided a system for protecting contents comprising: a first device for storing and reproducing contents purchased by a user; a server for issuing usage rights of contents; and a second device for reproducing contents protection mechanism-applied contents, and if contents to be copied from the first device are not protected by the protection mechanism, obtaining the usage rights from the server and converting the unprotected contents into contents under protection of the protection mechanism.

Preferably, in case that the contents to be copied from the first device are not protected contents, the second device includes an agent for being connected with the server with reference to URL (Uniform Resource Locator) information contained in the contents and receives a certain trigger from the server.

Preferably, when the agent checks that it has received the trigger, it transmits information required for obtaining contents usage rights to the server, obtains contents usage rights from the server, and receives information on the contents usage rights obtained from the server.

Preferably, the contents protection mechanism is DRM (Digital Rights Management).

Preferably, if contents to be copied to the second device are not protected contents, the first device is connected with the server with reference to URL information contained in the contents and receives a certain trigger from the server.

Preferably, the second device is a media reproducing device.

Preferably, the server shares contents purchase information and payment information managed by contents stores (contents provider).

Preferably, the contents conversion refers to encrypting (encoding) of the contents so as to be protected by the protection mechanism.

To achieve at least these advantages in whole or in parts, there is further provided a method for protecting contents comprising: when contents of a first reproducing device is copied to a second reproducing device employing a certain contents protection mechanism, checking whether the contents are under the protection mechanism; if the contents are not protected by the protection mechanism, connecting by the second reproducing device to a server to obtain contents usage rights; and converting by the second reproducing device the unprotected contents into contents protected by the protection mechanism based on the obtained rights.

Preferably, the contents protection mechanism is DRM (Digital Rights Management).

Preferably, the step of obtaining usage rights comprises connecting by the second reproducing device to the server with reference to URL information contained in the contents and receiving a certain trigger from the server; transmitting by the second reproducing device information required for obtaining the contents usage rights to the server when the reception of the trigger is checked; and transferring the information on the contents usage rights obtained from the server to the second reproducing device.

To achieve at least these advantages in whole or in parts, there is further provided a method for protecting contents comprising: when contents of a first reproducing device is copied to a second reproducing device employing a certain contents protection mechanism, checking whether the contents are under the protection mechanism; if the contents are not protected by the protection mechanism, connecting by the first reproducing device to a server to obtain contents usage rights; and converting by the first reproducing device the unprotected contents into contents protected by the protection mechanism based on the obtained rights.

Preferably, the step of obtaining usage rights comprises connecting by the first reproducing device to the server with reference to URL information contained in the contents and receiving a certain trigger from the server; transmitting by the first reproducing device information required for obtaining the contents usage rights to the server when the reception of the trigger is checked; and transferring the information on the contents usage rights obtained from the server to the first reproducing device.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of a contents protecting system in accordance with the present invention;

FIG. 2 illustrates an operation process of the contents protecting system in accordance with a first embodiment of the present invention;

FIG. 3 illustrates an operation process of the contents protecting system in accordance with a second embodiment of the present invention;

FIG. 4 illustrates a schema definition showing a format of a <importContent-Request> message;

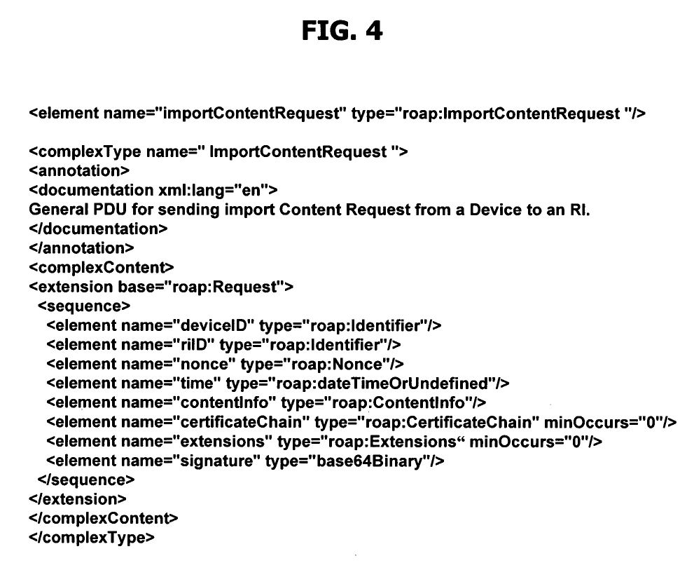

FIG. 5 illustrates a schema definition showing a format of a <importContentResponse> message; and

FIG. 6 illustrates a schema definition showing a format of a <importContentTrigger>.

### DETAILED DESCRIPTION OF THE INVENTION

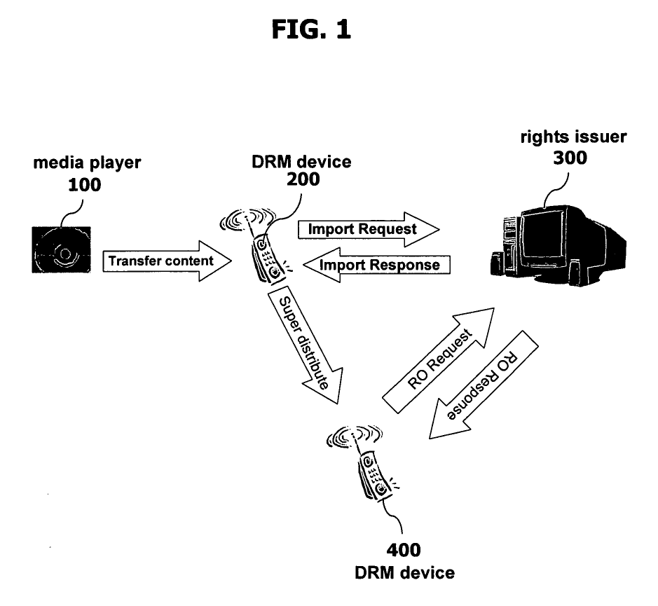

FIG. 1 illustrates the structure of a contents protecting system in accordance with the present invention.

As shown in FIG. 1 a contents protecting system in accordance with the present invention comprises a first device 100 (referred to hereinafter as a ‘media player’) for storing and reproducing contents purchased by a user, a server 300 (referred to hereinafter as ‘rights issuer’) for issuing usage rights of contents, and a second device 200 (referred to hereinafter as ‘mobile media player’) for converting unprotected contents so as to be protected by a DRM according to the usage rights issued by the rights issuer 300 when the contents are copied from the media player 100 and determined as the unprotected contents.

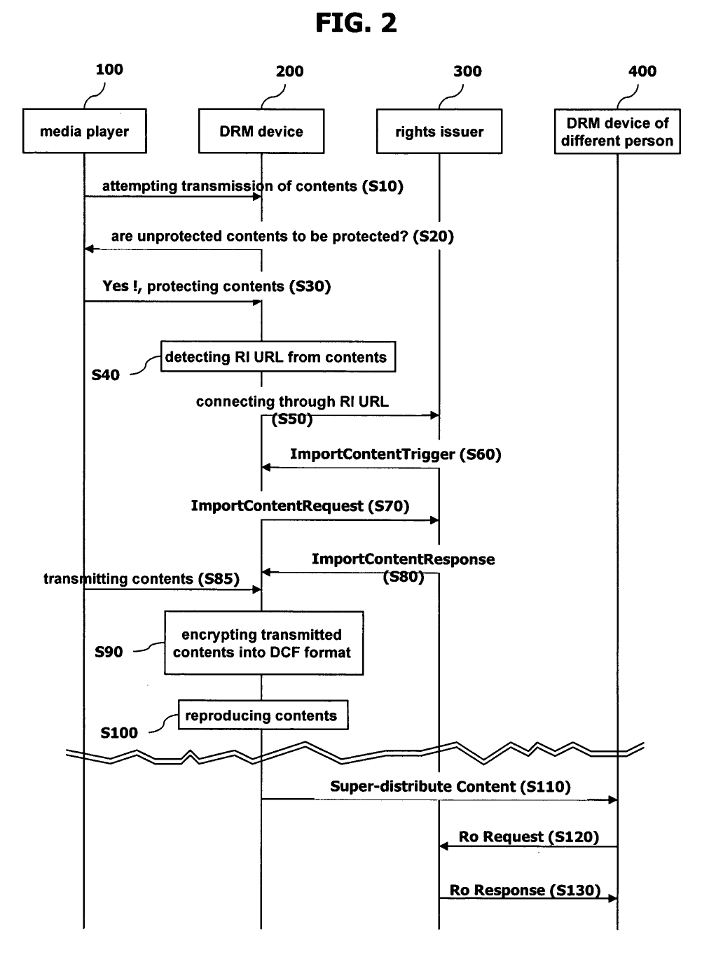

FIG. 2 illustrates an operation process of the contents protecting system in accordance with a first embodiment of the present invention.

Preferred embodiments of the present invention will now be described with reference to FIGS. 1 and 2.

In general, a user buys media contents such as audio contents or video contents from genera stores (offline market) or Internet online market, and enjoys them by using various media players (e.g., an audio player, a desktop computer, etc.). For the sake of explanation, it is assumed that the media player 100 is a product without having a contents protection technique applied thereto, while the purchased contents are audio contents.

When the user wants to enjoy the purchased contents through the mobile media player 200 such as a small MP3 player or a mobile terminal (a notebook, a PDA (Personal Digital Assistant, etc.), the user can transmit the contents to the mobile media player 200 by using a communication cable such as a USB (Universal Serial Bus) (step S10). In this embodiment, it is assumed that the mobile media player 200 is a contents protection technique (e.g., the DRM)-applied product.

When the user attempts transmission of the contents (step S10), a DRM agent (not shown) mounted in the mobile media player 200 checks whether the contents are contents protected by the DRM. If the contents are not protected by the DRM, the DRM agent notifies the user that the contents are not protected by the DRM and transmission is not allowable and prompts the user to convert the unprotected contents into protected contents and obtain contents usage rights (step S20).

When user's agreement with respect to obtaining of the usage rights is obtained (step S30), the DRM agent is connected with the rights issuer 300 by using a URL (Uniform Resource Locator) of the rights issuer 300 detected from the purchased storage medium (or contents) (steps S40 and S50). If the purchased storage medium does not have the URL information of the rights issuer, the DRM agent is connected with the rights issuer 300 through URL information set therein.

Being connected with the rights issuer 300, the DRM agent receives <import-ContentTrigger> from the rights issuer 300 (step S60). When reception of the <ImportContent-Trigger> is checked, the DRM agent starts import operations (step S70 and S80).

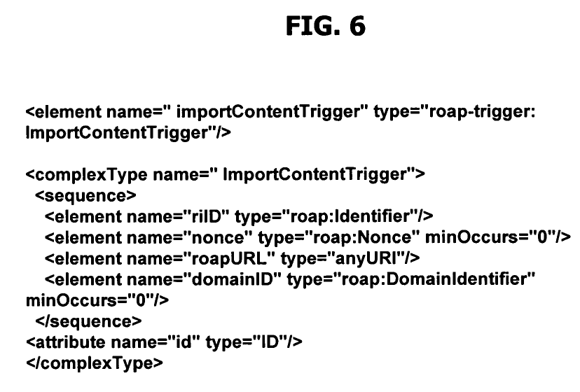

The <importContentTrigger> is a trigger newly proposed in the present invention and its format is described in a DRM 2.0 specification. FIG. 6 illustrates a format of <importContentTrigger> showing a schema definition.

If its URL information is not valid, the DRM agent can request the connected rights issuer 300 to send valid URL of the rights issuer 300 thereto.

Upon receiving <ImportContentTrigger>, the DRM contents includes information (contents information such as a serial number, an album, an artist, etc.) detected from the storage medium in a certain request message (e.g., importContentRequest) and transmits it to the rights issuer 300 (step S70).

Upon receiving the request message, the rights issuer 300 includes information such as a rights encryption key, a contents ID, a rights object or the like in a certain response message (e.g., importContentResponse) and transmits it to the DRM agent (step S80).

When the response message of the rights issuer 300 arrives, the DRM agent encrypts the contents purchased by the user into a suitable DCF (protected contents format) of the DRM by using the information included in the response message (steps S85 and S90). Encrypting of the contents is a process of converting unprotected contents into protected contents, which is performed by the DRM agent while the contents are being transmitted to the DRM device (namely, the mobile media player).

After the above operations (steps S10 to S90) are successfully performed, the user obtains a rights object recognizing that the purchased contents can be legally used in the mobile media player 200 of his/her own, and accordingly, the user can freely use the contents in the mobile media player 200 just like other contents protected by the DRM (step S100).

Once the usage rights with respect to the specific contents is issued, the rights issuer 300 prevents access of a <importContentRequest> message having the same serial number as that of the contents, in order to prevent repeatedly generating usage rights with respect to single contents.

In addition, the rights issuer 300 can issue an authority for the user to use contents in several devices as well as in one device under the protection of the DRM. Such authority is a contents domain authority and issued by the rights issuer 300 according to a request from the user.

Moreover, as shown in the process of steps S110 and S120 in FIG. 2, a super-distribution process allowing the user 100 to distribute the contents protected by the DRM to a different user 400 can be performed. When the different user 400 receives super-distributed contents from the user 100, a DRM agent of the different user 400 can obtain a URL from a silent-headers field of a DCF and request usage rights of the contents from the rights issuer 300 according to a definition of a corresponding DRM specification (e.g., DRM 2.0 specification) by using a normal 2 pass RO-Acquisition protocol.

Charging for the contents usage rights is made by the rights issuer 300. Namely, as in the step S70, when the user requests usage rights with respect to specific contents, the rights issuer 300 searches a purchase and payment record with respect to the corresponding contents, and then, determines whether to charge the user based on the search result.

If the user has already paid contents usage fee to a music publisher when he/she bought the contents, the rights issuer 300 does not charge the user. IN order to prevent repeated charging over the user, the rights issuer 300 must share contents purchase information and payment information managed by the music publisher.

If the DRM device (mobile media player) is an unconnected device without having a wireless communication module therein, the DRM agent can perform a communication mechanism (steps S50 to S80) through a connected device such as a desktop computer.

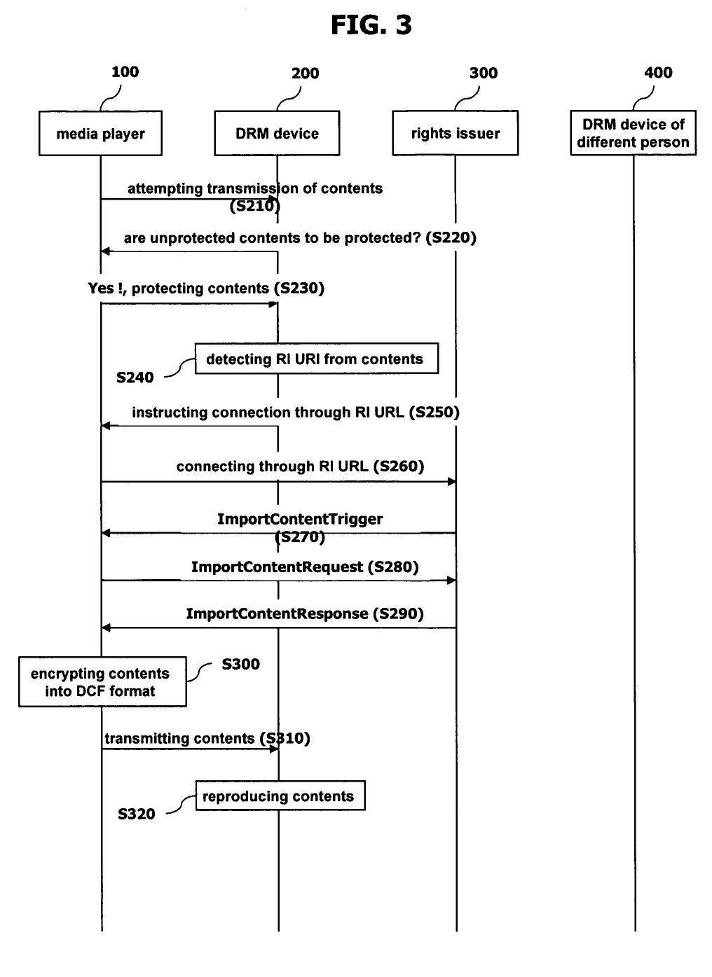

FIG. 3 illustrates an operation process of the contents protecting system in accordance with a second embodiment of the present invention.

The second embodiment of the present invention shows a case where the DRM device (the mobile media player) is an unconnected device without having a wireless communication module therein and performs operations under the same assumption likewise as in the first embodiment of the present invention.

The second embodiment of the present invention will now be described with reference to FIGS. 1 and 3.

When a user wants to enjoy purchased contents in the mobile media player 200, the user can transmit the contents to the mobile media player 200 through a communication cable (step S210).

When the user attempts transmission of the contents (step S210), a DRM agent (not shown) mounted in the mobile media player 200 checks whether the contents are contents protected by the DRM. If the contents are not protected by the DRM, the DRM agent notifies the user that the contents are not protected by the DRM and transmission is not allowable and prompts the user to convert the unprotected contents into protected contents and obtain contents usage rights (step S220).

When user's agreement with respect to obtaining of the usage rights is obtained (step S230), the DRM agent detects a URL of the rights issuer 300 from the purchased storage medium (or contents) and instructs the media player 100 to be connected with the rights issuer 300 by using the detected URL of the rights issuer 300 (step S250). If the purchased storage medium does not have the URL information of the rights issuer, the DRM agent instructs the media player 100 to be connected with the rights issuer 300 through URL information set therein.

Being connected with the rights issuer 300, the media player 100 receives <import-ContentTrigger> from the rights issuer 300 (steps S260 and S270). When reception of the <ImportContent-Trigger> is checked, the media player 100 starts import operations (step S280 and S290).

The <importContentTrigger> is a trigger newly proposed in the present invention and its format is described in a DRM 2.0 specification. FIG. 6 illustrates the format of <importContentTrigger> showing a schema definition.

If its URL information is not valid, the DRM agent can request the connected rights issuer 300 to send valid URL of the rights issuer 300 through the media player 100.

Upon receiving <ImportContentTrigger>, the media player 100 includes information (contents information such as a serial number, an album, an artist, etc.) detected from the storage medium in a certain request message (e.g., importContentRequest) and transmits it to the rights issuer 300 (step S280).

Upon receiving the request message, the rights issuer 300 includes information such as a rights encryption key, a contents ID, a rights object or the like in a certain response message (e.g., importContentResponse) and transmits it to the media player 100 (step S290).

When the response message of the rights issuer 300 arrives, the media player 100 encrypts the contents purchased by the user into a suitable DCF (protected contents format) of the DRM by using the information included in the response message(step S300). Encrypting of the contents is a process of converting unprotected contents into protected contents, and the user stores the encryption-completed contents in the mobile media player 200 (step S310).

After the above operations (steps S210 to S310) are successfully performed, the user obtains a rights object recognizing that the purchased contents are qualified (or authenticated) contents (leally), and accordingly, the user can freely use the contents in the mobile media player 200 just like other contents protected by the DRM (step S320).

In order to implement the above embodiments, in the present invention the ROAP protocol-based request message and response message used in the import operations (S70 and S80) are defined as follows.

<importcontentRequest> is an example of the request message, which is transmitted by the OMA DRM agent to request usage rights of the purchased contents from the rights issuer 300, and <importContentResponse> is an example of the response message, namely, the response message of the rights issuer 300 with respect to the <importContentRequest>.

[Table 1] shows an example of the <importContentRequest> message format in accordance with the present invention.

TABLE 1
ROAP-importContentRequest

| Parameter | Mandatory(M)/Operational(O) |
|---|---|
| DeviceID | M |
| RI ID | M |
| Device Nonce | M |
| Request Time | M |
| Import Content Info | M[k1] |
| Certificate Chain | O |
| Extensions | O |
| Signature | M |

As shown in [Table 1], in the present invention, the <importContentRequest> message includes Import Content Inform to allow the rights issuer 300 to determine a type of contents. The Import Content Info is an XML complex type comprising elements such as a serial No, a title, an album, a CopyRightinfo, a TypeOfContent, and the like.

The serial No is a field storing a serial number assigned to contents, and every transacted contents has a serial number. The title is a field storing a title of contents. The album, a name given to a set of contents, is a field storing a name representing the entire contents purchased by the user. The album includes a plurality of tracks.

The CopyRightlnfo is a field storing copyright information. When the copyright information is included in a purchased media, the copyright information is stored in the CopyRightinfo field and transmitted to the rights issuer 300. The typeOfContent is a field storing information regarding a type of purchased media.

[Table 2] shows elements of the Import Content Info.

TABLE 2

| Serial | | |
|---|---|---|
| No. | Element Name | Details |
| 1 | Serial No | This is a unique number of the imported content |
| | | if present |
| 2 | Title | This element specifies the title of the Content if |
| | | present |
| 3 | Album | This is a generic name of the whole set of |
| | | contents (an album has many tracks in it) |
| 4 | CopyRightInfo | If this media has any Copy Rights Information |
| | | present in the media. If copy Right Information |
| | | is present in the imported media then this |
| | | information is sent to the RI in this field. |
| 5 | TypeOfContent | This element specifics the types of content |
| | | which is imported into the DRM agent |

[Table 3] shows an example of the <importContentResponse> message format in accordance with the present invention.

TABLE 3
ROAP-importContentResponse

| | Mandatory (M)/ | |
|---|---|---|
| Parameter | Operational (O) | Details |
| DeviceID | M | Device ID (Identifier) |
| RI ID | M | ID of rights issuer |
| Device Nonce | M | Nonce for the response |
| Content ID | M[k2] | Newly added field |
| Silent URL | O[k3] | Newly added field |
| Copy Right Information | O[k4] | Newly added field |
| ProtectedRO | M | Rights object included |
| Certificate Chain | O | Chain of valid certificates |
| OCSP Response | O | Valid OCSP response for |
| | | the certificates |
| Extensions | M | Extension field |
| Signature | M | Message signature |

As shown in [Table 3], the <importContentResponse> message additionally includes the Content ID, Silent URL and Copy Right Information. When the rights issuer 300 determines to protect corresponding contents, an encryption key is stored in the field of ProtectedRO of the <importContent-Response> message.

The contents ID is a field for storing an ID of contents protected by the DRM agent. The contents ID field is used for the DRM agent to generate DRM 2.0 contents and generated by the rights issuer 300.

The Silent URL is a field for storing Silent URL generated by the rights issuer 300 and is used for the DRM agent to constitute the DRM 2.0 CONTENTS.

The Copy Right Information is a field for storing copyrights information generated by the rights issuer 300 and is used for the DRM agent to constitute DRM 2.0 contents.

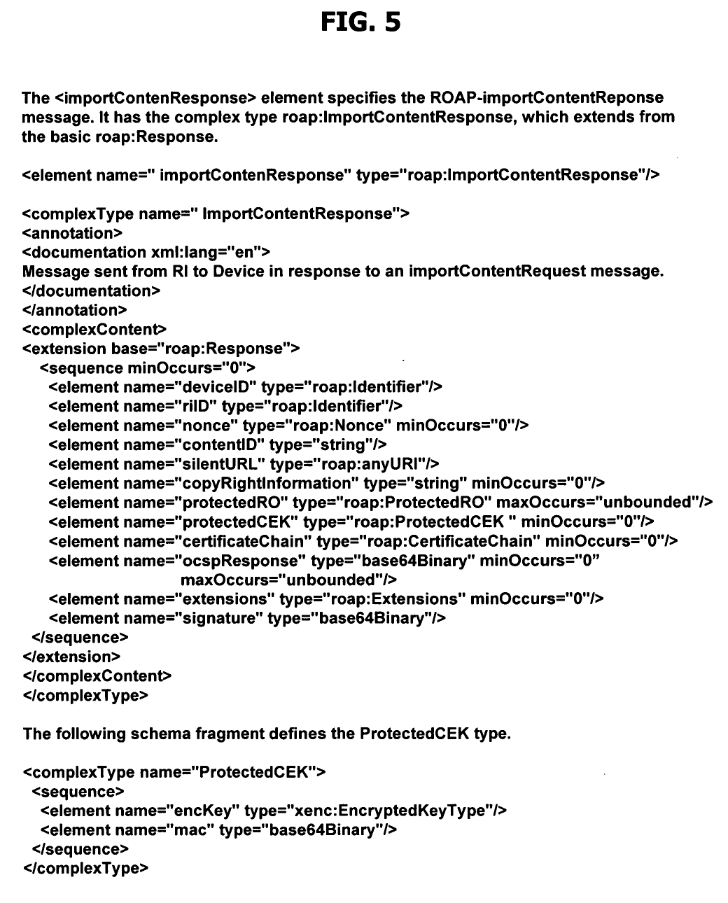

Schema definitions in FIGS. 5 and 6 show a format of the <importContent-Request> message and the <importContentResponse> message, respectively.

As so far described, the contents protecting system and method in accordance with the present invention have many advantages.

That is, for example, when contents purchased by the user is not protected by the DRM, the DRM-employed reproducing device can obtain usage rights with respect to the corresponding contents from the rights issuer. And then, the purchased contents are converted into the contents that can be protected by the DRM. Accordingly, in the present invention, the contents that is not protected by the DRM can be enjoyed through the DRM-employed reproducing device without causing a problem legally, and thus, user inconvenience of separately and additionally purchasing contents protected by the DRM and a corresponding financial loss can be reduced.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A system for protecting contents comprising:
a first device for storing and reproducing contents purchased by a user;
a server for issuing usage rights of contents; and
a second device for reproducing contents protection mechanism-applied contents, and if contents to be copied from the first device are not protected by the protection mechanism, obtaining the usage rights from the server and converting the unprotected contents into contents under protection of the protection mechanism.

2. The system of claim 1, wherein if the contents to be copied from the first device are not protected contents, the second device includes an agent for being connected with the server with reference to URL (Uniform Resource Locator) information contained in the contents and receives a certain trigger from the server.

3. The system of claim 2, wherein when the agent checks that it has received the trigger, it transmits information required for obtaining contents usage rights to the server, obtains contents usage rights from the server, and receives information on the contents usage rights obtained from the server.

4. The system of claim 1, wherein the contents protection mechanism is DRM (Digital Rights Management).

5. The system of claim 1, wherein if contents to be copied to the second device are not protected contents, the first device is connected with the server with reference to URL information contained in the contents and receives a certain trigger from the server.

6. The system of claim 5, wherein when the first device checks that it has received the trigger, it transmits information required for obtaining contents usage rights to the server, obtains contents usage rights from the server, and receives information on the contents usage rights obtained from the server.

7. The system of claim 1, wherein the second device is a media reproducing device.

8. The system of claim 1, wherein the server shares contents purchase information and payment information managed by contents stores.

9. The system of claim 1, wherein the content conversion refers to encrypting of the contents so as to be protected by the protection mechanism.

10. A method for protecting contents comprising:
when contents of a first reproducing device is transmitted to a second reproducing device employing a certain contents protection mechanism, checking whether the contents are under the protection mechanism;
if the contents are not protected by the protection mechanism, connecting by the second reproducing device to a server to obtain contents usage rights; and
converting by the second reproducing device the unprotected contents into contents protected by the protection mechanism based on the obtained rights.

11. The method of claim 10, wherein the contents protection mechanism is a DRM (Digital Rights Management).

12. The method of claim 10, wherein the step of obtaining usage rights comprises:
connecting by the second reproducing device to the server with reference to URL information contained in the contents and receiving a certain trigger from the server;
transmitting by the second reproducing device information required for obtaining the contents usage rights to the server when the reception of the trigger is checked; and
transferring the information on the contents usage rights obtained from the server to the second reproducing device.

13. The method of claim 12, wherein, in the step of receiving a trigger, the second device is connected with the server with reference to URL information set in the second device.

14. The method of claim 10, wherein the second device is a mobile media reproducing device.

15. The method of claim 10, wherein the server shares contents purchase information and payment information of contents stores.

16. The method of claim 10, wherein, in the step of converting the contents, the contents are encrypted so as to be protected by the protection mechanism.

17. A method for protecting digital contents of a media reproducing device comprising:
attempting transmission of contents by a first device without having a digital contents protection mechanism therein to a second device employing the contents protection mechanism;
if the contents are not protected by the mechanism, receiving by the first device a message proposing that the contents be converted into protected contents from the second device; and
accepting the proposal, and transmitting the contents to the second device when the second device obtains usage rights of the contents.

18. The method of claim 17, wherein the second device is a mobile media reproducing device.

19. The method of claim 17, wherein the contents protection mechanism is a digital rights management (DRM).

20. A method for protecting digital contents in an apparatus where a digital contents protection mechanism is employed, comprising:
when contents are received from a certain device, checking whether the contents are protected by the contents protection mechanism;
if the contents are not protected by the mechanism, rejecting reception of the contents and connecting to a server to obtain usage rights for the contents; and
when usage rights for the contents is obtained, withdrawing the rejection of reception to receive the contents, and converting the received contents into contents which can be protected by the mechanism based on the obtained rights.

21. The method of claim 20, wherein the contents protection mechanism is a digital rights management (DRM).

22. The method of claim 20, wherein the step of obtaining usage rights comprises:
connecting to the server with reference to URL information contained in the contents and receiving a certain trigger from the server;
when reception of the trigger is checked, transmitting information required for obtaining the contents usage rights to the server; and
obtaining contents usage rights from the server.

23. The method of claim 22, wherein, in the step of receiving the trigger, connection is made to the server with reference to the URL information set in the media reproducing device.

24. The method of claim 20, wherein the media reproducing device is a mobile device.

25. The method of claim 20, wherein the server shares contents purchase information and payment information of contents stores.

26. The method of claim 20, wherein, in the step of converting the contents, the contents are encrypted so as to be protected by the protection mechanism.

27. A method for protecting digital contents of a media reproducing device comprising:
attempting transmission of contents by a first device, to which a digital rights management (DRM) is not applied, to a second device to which the DRM is applied;
if the contents are not protected by the DRM, proposing by the second device that the first device convert the contents into DRM contents;
if the first device accepts the proposal, connecting by the second device to a server with reference to URL information contained in the contents and receiving a certain trigger from the server;
when reception of the trigger is checked, transmitting by the second device information required for obtaining contents usage rights to the server;
receiving by the second device information on contents usage rights from the server;
transmitting by the first device the contents to the second device; and
converting by the second device the received contents into DRM contents based on the obtained rights.

28. The method of claim 27, wherein the second device is a mobile media reproducing device.

29. The method of claim 27, wherein, in the step of converting the contents, the contents are encrypted so as to be protected by the DRM.
